(19) United States
(12) Patent Application Publication
(10) Pub. No.: US 2005/0129836 A1
(43) Pub. Date: Jun. 16, 2005

(54) Honey extender

(75) Inventor: Bernard Charles Sekula, Glen Gardner, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Bestfoods North America

(21) Appl. No.: 10/735,539

(22) Filed: Dec. 12, 2003

(51) Int. Cl. A23G 3/00

(52) U.S. Cl. 426/658

(57) ABSTRACT

The invention is directed to a honey extender and a honey comprising composition having the honey extender. The honey comprising composition has elevated levels of oligosaccharides and does not display sugar crystallization when stored at ambient temperature for at least about three years.

### FIELD OF THE INVENTION

The present invention is directed to a honey extender. More particularly, the invention is directed to a honey extender that, unexpectedly, can be used to make a honey comprising composition that has taste characteristics that are substantially the same as those of conventional honey. The honey comprising composition with the honey extender of this invention has a higher moisture content than honey, does not display crystallization characteristics for at least about three years at ambient temperature, and has excellent flowability properties. Furthermore, the honey comprising composition with the honey extender of this invention has microbiological stability indistinguishable from that of conventional honey, even with the higher moisture content.

### BACKGROUND OF THE INVENTION

Honey is the oldest sweetener used by many and it is manufactured in nature's most efficient factory, the beehive. Bees make honey from the nectar of flowers and they often travel tens of thousands of miles and visit millions of flowers to produce a single pound of honey. While very popular, honey is expensive, typically sold at more than $1.60 per pound.

Honey types include Sourwood and Wildflower honey, the former from flowers of the Sourwood Tree (Oxydendrum Arboreum) and the latter from a variety of flowers, like tulip poplar, blackberry, basswood, black locus, maple and wild blueberry flowers.

Honey is enjoyed by consumers in numerous food applications. For example, honey is an important baking ingredient, is used in many sauce and dip recipes, and is enjoyed in beverages, like tea. Honey can also be used as a spread, or a topping for fruits, ice cream, or the like.

Notwithstanding the above applications, honey can be difficult to work with since it typically displays sugar crystallization when stored at ambient temperature, the usual kitchen cupboard temperature. Subsequent to such sugar crystallization, honey can be difficult to remove from a jar and can even render a jar impossible to open without heating its cap in hot water. Moreover, crystallized honey is often discarded, and when not discarded, hard to utilize because it is difficult to mix honey with sugar crystals homogeneously into a desired food product.

It is of increasing interest to develop an affordable honey comprising product that is microbiologically stable and does not crystallize at ambient temperature. This invention, therefore, is directed to a honey extender that, unexpectedly, can be used to make a honey comprising composition that is microbiologically stable, has taste characteristics that are substantially the same as conventional honey and does not display crystallization characteristics for at least about three years at ambient temperature. Moreover, the honey comprising composition of this invention not only has the taste of conventional honey, but it is approximately 200.0% cheaper to purchase than honey, a real advantage for developing nations.

### ADDITIONAL INFORMATION

Efforts have been disclosed for making honey substitutes. In U.S. Patent Application No. 20030049357 A1, a honey tasting composition with viscosifiers, gums and non-nutritive sweeteners is described.

Other efforts have been disclosed for making edible compositions. In EP 1249177 A1, a multifunctional food base for honey substitutes and fluid foods is described.

Still other efforts have been disclosed for making honey-like products. In U.S. Pat. No. 5,447,743, a honey substitute with polysaccharides and polyalcohols is described.

None of the additional information above describes a honey comprising composition comprising a honey extender wherein the honey comprising composition has the taste and microbiological stability of conventional honey, and does not crystallize for at least about three years at ambient temperature.

### SUMMARY OF THE INVENTION

In a first aspect, the present invention is directed to a honey extender comprising:

a) at least about 7.0% by weight oligosaccharide;

b) at least about 60.0% by weight corn syrup having a D.E. of at least about 36; and

c) water

wherein weight percent is based on total weight of the honey extender.

In a second aspect, the present invention is directed to a honey composition that comprises the honey extender of the first aspect of this invention.

Honey extender, as used herein, means a composition suitable to be mixed with conventional honey to yield a honey comprising composition that does not display sugar crystallization and that has the taste and microbiological stability of conventional honey. Conventional honey, as used herein, means honey typically purchased in a supermarket and having about 5.0% or less by weight oligosaccharide. Microbiologically stable means no outgrowth of bacteria, yeast and/or mold for at least three years at ambient temperature in a capped glass jar that has been occasionally opened and closed. Substantially the same taste as conventional honey means that at least one half of the panelists tasting the honey comprising composition comprising the honey extender of this invention cannot distinguish the same from conventional honey.

High water content means at least about 19.0% by weight water based on total weight of the honey comprising composition comprising the honey extender. Excellent flowability properties means that the honey comprising composition comprising the honey extender has a viscosity similar to that of conventional honey but is easier to pour.

### DETAILED DESCRIPTION OF THE PREFERRED EMBODIMENTS

There is no limitation with respect to the type of oligosaccharide (or mixture of oligosaccharides) that may be used in this invention other than that the oligosaccharide, when combined with honey, does not result in a composition with a grainy texture. Preferred oligosaccharides suitable for use in this invention have backbones that comprise glucose, fructose or both glucose and fructose units. In an especially preferred embodiment, the oligosaccharide used is a homo-oligosaccharide that has glucose units in its backbone.

The amount of oligosaccharide employed in the honey extender of this invention is at least about 7.0% by weight, based on total weight of the honey extender. In a preferred embodiment, the honey extender described herein comprises from about 7.5% to about 18.0%, and most preferably, from about 8.0% to about 12.5% by weight oligosaccharide, based on total weight of the honey extender and including all ranges subsumed therein. In another preferred embodiment, the oligosaccharide employed herein comprises from about 3 to about 25 monomeric units, and preferably, from about 3 to about 10 monomeric units in its backbone, including all ranges subsumed therein.

The honey extender of this invention comprises at least about 60.0% by weight corn syrup, and preferably, from about 65.0% to about 95.0% by weight, and most preferably, from about 75.0% to about 90.0% by weight corn syrup, based on total weight of honey extender and including all ranges subsumed therein.

The corn syrup suitable for use in this invention is preferably a mixture of corn syrups wherein the mixture of corn syrups is preferably at least about 55.0% by weight high fructose corn syrup, based on total weight of the corn syrup mixture. In a most preferred embodiment, the corn syrup mixture comprises from about 60.0% to about 90.0% by weight high fructose corn syrup, including all ranges subsumed therein.

The corn syrups used in this invention usually have a D.E. (dextrose equivalent) greater than about 36 and typically from about 36 to about 48. In a preferred embodiment, the corn syrups used in this invention have a D.E. from about 38 to about 46, and most preferably, from about 40 to about 44, including all ranges subsumed therein.

It is preferred that the honey extender of the present invention comprises from about 30.0% to about 40.0% by weight glucose and from about 40.0% to about 50.0% by weight fructose, based on total weight of the honey extender and including all ranges subsumed therein.

In an especially preferred embodiment, the honey extender of this invention comprises less than about 3.5% by weight maltose, and preferably, from about 1.75% to about 2.25% by weight maltose, based on total weight of the honey extender and including all ranges subsumed therein. Water is typically the balance and usually added with the corn syrup or mixture of corn syrups employed.

In yet another especially preferred embodiment, the honey extender of this invention comprises from about 20.0% to about 25.0% by weight water (based on total weight of the honey extender) and is essentially free of viscosifiers like water-soluble and water-dispersible hychocolloids, and non-nutritional sweeteners like sucralose, aspartame, noctame, cyclamate and saccharin, where essentially free means less than 0.2% by weight (based on total weight of the honey extender), and preferably, 0.0% by weight.

When making the honey extender of the present invention, the ingredients (i.e., corn syrup, oligosaccharides and saccharides) are mixed under moderate sheer in no particular order until a transparent honey extender is produced. The mixing can take place under atmospheric pressure and at ambient temperature or at elevated pressure and/or temperature.

When making the honey comprising composition comprising the honey extender of the present invention, commercially available honey is mixed with the honey extender of this invention to surprisingly produce a composition that tastes substantially the same as honey, is microbiologically stable and does not display crystallization characteristics at ambient temperature for at least about three years, and preferably, for at least about four years. The honey comprising composition typically comprises from about 10.0% to about 50.0%, and preferably, from about 15.0% to about 40.0%, and most preferably, from about 20.0% to about 30.0% by weight honey, based on total weight of honey and honey extender in the composition and including all ranges subsumed therein.

There is no limitation with respect to how the honey comprising composition comprising honey extender is packaged, but often the same is packaged in glass or plastic jars, or individual serving size packages.

The Examples below are provided to facilitate an understanding of the present invention. The Examples are not intended to limit the scope of the claims.

### EXAMPLE 1

Honey extenders were prepared by mixing the following ingredients at about 35° C.

| Ingredient* | % by Weight |
|---|---|
| Corn Syrup | 10.0-16.0 |
| High Fructose Corn Syrup | 72.0-76.0 |
| Crystalline Fructose | 13.0-22.0 |

The resulting honey extenders were transparent, free of crystallization and cooled to room temperature.

### EXAMPLE 2

Honey extenders similar to those prepared in Example 1 were made by mixing the following ingredients in a manner similar to the one described above.

| Ingredient* | % by Weight |
|---|---|
| Corn Syrup | 11.0-14.0 |
| High fructose corn syrup | 62.0-67.0 |
| Crystalline fructose | 18.0-21.0 |
| Sucrose | 1.0-2.0 |

*= as made commercially available by Casco, Inc.

The resulting honey extenders were transparent, free of crystallization and cooled to room temperature.

### EXAMPLE 3

Honey comprising compositions were made by mixing honey extenders similar to those described in Examples 1 and 2 with conventional honey sold under the Golden Blossom and Kallis White Clover brand names. The resulting honey comprising compositions comprising honey extenders had approximately 25.0% by weight honey based on total weight of honey and honey extenders. The resulting compositions were packaged in capped eight (8) ounce jars and stored at about ambient temperature for about 4.5 years. The caps were occasionally removed during the 4.5 year period and samples of product were tasted. Unexpectedly, the honey comprising compositions were microbiologically stable, had substantially the same taste as conventional honey and displayed no sugar crystallization, even in the cap region.

### EXAMPLE 4

Eight (8) ounce jars of store purchased honey were stored at room temperature. After about one (1) year significant, sugar crystallization appeared and the caps on the jars were difficult to remove.

### EXAMPLE 5

Approximately twelve (12) panelists were asked to sample the honey comprising compositions of Example 3 and conventional store purchased honey. Unanimously, the twelve panelists concluded that the honey composition comprising the honey extender of this invention had a taste that was indistinguishable from that of conventional honey.

1. A honey extender comprising:
a) at least about 7.0% by weight oligosaccharide;
b) at least about 60.0% by weight corn syrup having a D.E. of at least about 36; and
c) water
wherein weight percent is based on total weight of the honey extender.

2. The honey extender according to claim 1 wherein the honey extender comprises from about 7.5 to about 18.0% by weight oligosaccharide.

3. The honey extender according to claim 1 wherein the honey extender comprises from about 65.0% to about 95.0% by weight corn syrup.

4. The honey extender according to claim 1 wherein the corn syrup has a D.E from about 36 to about 48.

5. The honey extender according to claim 1 wherein the corn syrup has a D.E. from about 40 to about 44.

6. The honey extender according to claim 1 wherein the honey extender comprises from about 30.0% to about 40.0% by weight glucose, and from about 40.0% to about 50.0% by weight fructose.

7. The honey extender according to claim 1 wherein the honey extender comprises less than 3.5% by weight maltose.

8. The honey extender according to claim 1 wherein the honey extender comprises from about 1.75% to about 2.25% by weight maltose.

9. The honey extender according to claim 1 wherein the honey extender is from about 20.0% to about 25.0% by weight water.

10. The honey extender according to claim 1 wherein the honey extender is free of viscosifier and non-nutritional sweetener.

11. A honey comprising composition comprising:
a) honey; and
b) honey extender comprising:
(i) at least about 7.0% by weight oligosaccharide, based on total weight of the honey extender;
(ii) at least about 60.0% by weight corn syrup having a D.E. of at least about 36, based on total weight of the honey extender; and
(iii) water.

12. The honey comprising composition according to claim 11 wherein the composition comprises from about 10.0% to about 50.0% by weight honey, based on total weight of the honey comprising composition.

13. The honey comprising composition according to claim 11 wherein the composition comprises from about 20.0% to about 30.0% by weight honey, based on total weight of the honey comprising composition.

14. The honey comprising composition according to claim 11 wherein the composition does not display sugar crystallization at ambient temperature for at least about three years.

15. The honey comprising composition according to claim 14 wherein the composition has substantially the same taste as honey.
